(19) United States
(12) Patent Application Publication
(10) Pub. No.: US 2006/0093776 A1
(43) Pub. Date: May 4, 2006

(54) Pressure sensitive laminate assembly having faux patterned embossments for use with business communication documents and method of creating a business document

(76) Inventor: Jesse D. Crum, St. Fort Scott, KS (US)

Correspondence Address: Michael C. Maier, Esq.;Ward Kraft, Inc., P.O. Box 938, Fort Scott, KS, 66701, US

(21) Appl. No.: 11/112,460

(22) Filed: Apr. 22, 2005

Related U.S. Application Data
(63) Continuation-in-part of application No. 10/980,347, filed on Nov. 3, 2004.

(51) Int. Cl. B32B 33/00

(52) U.S. Cl. 428/40.1

(57) ABSTRACT

The present invention is found in the field of business communication documents, more particularly laminates for use with business communication documents such as pressure sensitive laminates. The laminate of the present invention includes a raised image that is created on a face or surface of the laminate through the use of a curable coating. The image on the laminate may be complimentary or substantially identical to a business communication that is provided on the business communication document. The laminate is applied to the business communication document through the use of an adhesive and is ideally used to accentuate a particular communication, such as marketing or advertising communications.

### CROSS-REFERENCES TO RELATED APPLICATIONS

This application is a continuation-in-part of application Ser. No. 10/980,347 filed Nov. 3, 2004 the disclosure of which including that found in the claims is incorporated herein by reference.

### FIELD OF THE INVENTION

The present invention is directed to laminates, more specifically pressure sensitive laminates having an adhesive layer. The laminate of the instant application may be applied to various substrates. This would include business communication documents such as business forms, stationery, advertising and marketing collateral and other office related materials. The laminate of the present invention may also be used as strips, labels, adhesive segments or the like. The laminate of the instant specification includes one or more patterns that may be created through the use of formable coatings to create textural, tactilely and visibly discernable images on the face of the laminate. The coatings may be applied so that they are complimentary to pre-determined indicia or images or may be applied in a variable arrangement so as to personalize a particular substrate to which the laminate is applied. More particularly the embodiments of the invention include a method of applying a coating to a surface of a material, creating an image in the coating while the coating is still in a fluid or intermediate state and then curing the coating to create a semi-permanent three dimensional image that resides on the substrate outer surface and is tactilely discernable from the remainder of the sheet or uncoated area.

### BACKGROUND OF THE INVENTION

The application of textures or finishes to substrates, particularly paper or cellulosic based materials, is relatively well known. In the conventional process of finishing or preparing paper substrates, the paper can undergo processing such as the imparting of designs or watermarks almost immediately as it comes off the drier of the machinery (the machinery that is involved in collecting the fibers, pressing and removing the moisture to form sheets) or the paper or fibrous mass can be collected and undergo further finishing or processing at a later time to create papers for specific uses or applications.

Such later processing may involve calendaring or super calendaring (the passage of the paper through steel rolls which produces a smoothness or glossiness on the surface of the paper). The amount and type of calendaring permits the surface of the substrate to vary greatly in smoothness. Exemplary types of finishes include antique, eggshell, vellum, smooth and luster (placed in order of increasing smoothness).

Other types of finishes, such as embossing, can also be applied to the paper after it leaves the paper making apparatus. Embossing is typically accomplished through the use of a rotary embosser, which impresses a particular pattern through the use of pressure rollers into the dry paper. That is, the sheet is fed through a nip which will have steel rollers that are used to press the pattern into the paper by deforming the surface of the paper, or mechanically crushing or crimping the paper. Common examples of embossed pattern papers include “tweed,” “linen” and “pebble,” which represent regular patterns of impressions created in the sheet of material and provide some level of tactile detection. Such embossed papers can be difficult to image as the embossments create a discontinuous surface thus making the printing appear blurred as the ink or toner traverses the surface of the sheet as well as the ridges and valleys created by the embossing equipment. That is, the ink or toner does not adequately fill such areas.

Conventionally embossed papers also suffer from the further draw back that each pattern requires a different set of steel rollers to be machined (male and female cut rolls) in order to achieve the desired design for the end user. Preparation of such rollers can cost hundreds if not thousands of dollars. Moreover, rollers will succumb to “wear and tear” and must be replaced. In addition, a manufacturer may be required to hold large inventories of such rollers in order to offer a variety of patterns, which obviously consumes an inordinate amount of space that could be used for other things like manufacturing.

Attempts have been made to manufacture paper sheets with patterns, such as those used in creating veneers without using the conventional mechanical embossing technique described above. For example, U.S. Pat. Nos. 4,532,157 and 4,652,482 use a relatively complex system in which multiple coatings (inks and resins) are either applied to areas or alternatively are washed from areas that have not been impregnated with a particular resin. Then the selected areas are overprinted with inks to produce the desired appearance. After that, the paper is permitted to dry for a period of time (two months—see examples) and then the sheets are lacquered to produce a wood grain pattern in the sheet. The sheets produced are used for veneers for furniture and paneling.

U.S. Pat. No. 5,246,785 describes another process for creating a pattern on the surface of a sheet that is used in creating veneers and the like, such as those that may appear in connection with paneling and furniture. The reference includes the relatively complex application of a series of resins and inks in selected areas to accomplish the objective of producing the particular pattern of interest which is then dried and applied to the panel or furniture.

The use of embossed papers has been limited in the field of business communication due primarily to cost and other difficulties such as printing an image in the area of the embossments. Embossed papers, such as linen are often several times more expensive than papers which have not been embossed. This coupled with the difficulty of printing the sheets has limited the use or application of the sheets. An example of such use includes the use of the sheets as external panels of booklets and the like. Thus, application or use of embossed papers has been largely limited to those projects where marketing budgets are sufficient to cover the additional expense or where the product or service can simply demand the additional cost associated with the use of the papers, such as with greeting cards where it is not unusual to pay several dollars per card.

Even though embossed papers are attractive and would aid in the delivery of a marketing or advertising message, it has been suggested that if an economical and efficient process were available, that such patterned papers would be more widely used and accepted in the industry. Therefore, what is needed is an efficient manner by which to create a substrate or business communication document that has the appearance of being constructed from an embossed sheet but can be created without the disadvantages of cost or time. The present invention provides the ability to add text or other complimentary graphics prior to the application of the coating in order to produce such documents or problems with applying an image to the document that is to be used for the communication piece. The subject of the present invention also includes the formation of pressure sensitive laminates that can be applied to other substrates or materials thereby providing the user with means to further enhance the message that is to be communicated.

Publications, patents and patent applications are referred to throughout this disclosure. All references cited herein are hereby incorporated by reference.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

In one exemplary embodiment of the present invention, a laminate for use with business communication documents is described and includes a substrate that has top and bottom faces with an adhesive that has been applied to the bottom face of the laminate. A coating is applied to the top face and is used to create a tactilely discernable pattern that is formed by curing the coating on the top face after the coating has been applied to the substrate. A carrier or liner is applied over the adhesive to form the laminate.

In the presently described embodiment a business communication document that has first and second faces is provided. The business communication document has personalized indicia provided thereon as well as printed, static or fixed information imaged on at least the first face. The laminate is then applied to the first face in proximity of the personalized indicia to form a personalized communication.

In a further exemplary embodiment of the present invention, a business communication document is provided and includes a printable substrate that has first and second faces, with at least the first face being provided with a communication that is normally printed or imaged on the substrate. A laminate that has top and bottom faces, is also provided in this embodiment, in which the bottom face is provided with an adhesive and the top face has a raised image thereon that has been created from a curable varnish based coating. The laminate is adhered to the first face of the substrate.

In yet a further exemplary embodiment of the present invention, a method of preparing business communication documents that has a raised image laminate provided thereon is described and includes the steps of initially providing a substrate that has first and second faces. The substrate is capable of having or receiving a printed communication. Next, a communication is imaged on the substrate.

In continuing with the presently described embodiment, a laminate is created that has a raised image thereon. The raised image is formed by applying a curable coating to an exposed face of the laminate. Finally, the laminate is applied to a portion of the substrate through use of an adhesive that has been applied to a face of the laminate opposite of the face having the raised image thereon.

The laminate of the foregoing embodiments may be die cut to any sort of shape, design or configuration either before or after the curable coating has been applied. The laminate may be printed or imaged prior to the coating being applied so that additional messages or communications can be provided to the recipient. In addition, the laminate may be collected in a continuous format, such as roll or fan folded format before the laminate with the raised image is applied to the communication document.

The coating utilized in connection with the present invention is preferably a varnish based coating and may comprise 100% varnish or alternatively the coating may include a first component ranging from 0.1% to about 99.9% of a curable varnish and a second component ranging from around 0.1% to about 99.9%. The second component is selected from a group including pigments, dies, starches, waxes, silicones, stabilizers, drying aids, fragrances and combinations thereof.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated after referring to the following more detailed description of the presently preferred exemplary embodiments of the invention in conjunction with the accompanying drawings, of which:

FIG. 1 depicts a side view of an exemplary laminate prepared in connection with the present invention and illustrating the raised image of the top surface;

FIG. 1A shows a front view of the top face of the laminate depicting the raised image;

FIG. 2 provides a further exemplary embodiment of the present invention and includes a die cut arrangement of the laminate;

FIG. 3 illustrates the laminate used in connection with a business communication document and having similar indicia to the printed and personalized message;

FIG. 3A provides a side elevation of the laminate used with the business communication document with the raised image created by the coating hereof;

FIG. 4 presents an exemplary block diagram setting forth preferred steps of carrying out the invention; and

FIG. 5 depicts a schematic of the apparatus used in carrying out the present invention.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

Surprisingly, it has been discovered that patterns, not only those which resemble traditional embossments, but also unique configurations such as company logos, images, shapes, designs, etc. can be created without the need to prepare expensive overlays, bases, rollers or the necessity of calendaring methods heretofore previously known. In addition, through the use of the present embodiments it has been discovered that a significantly higher degree of variability can be provided to the end user. By producing the invention in a pressure sensitive laminate assembly, adhesive segments, strips, labels and the like can be created to accentuate business communications.

The term “patterns” as used herein refers to strips, lines, shapes, spots, dots, elements, and discontinuous segments as well as regular and irregular placement of such items. Patterns may also refer to combinations of the above mentioned items such that one pattern may be a continuous strip, another segmented elements and a still further an irregular placement of elements or the like. Any combination of patterns is possible depending on the need or application of the manufacturer or the end user. In addition, the pattern can also be prepared in order to accommodate a particular theme, season, event, trade dress, graphics, alpha and numeric characters and the like. For example, one may wish to include a name of a company in connection with a particular theme or season.

The term “basis weight” as used herein is the weight in pounds of a ream (500 sheets) of paper cut to a given standard size for that grade. For example 500 sheets of 8½″ by 11″ of bond paper weighs 20 pounds.

As used herein the term “business communication piece or document” is used to refers to a substrate that when used either alone or in combination with other documents can convey a particular message, image or provide information about a particular product or service that is available from the provider of such pieces or documents. Business communication documents or pieces can consist of business forms, stationery, business cards, advertising, sales and marketing collateral and such other items used to convey information in a written or imaged form for example, the use of mailers, product sheets, brochures, presentation folders, informational sheets and combinations thereof.

The term “personalized information” refers to information that is printed or imaged onto a substrate and which is generally variable or unique. The information changes from document to document creating a customized message or communication for each recipient. Personalized information may include for example names, addresses, places of interest, descriptions, hobbies or habits, plans, etc. that may have been acquired through or from the intended recipient through completion of surveys answering questionnaires or by responding to various inquiries.

The term “static or fixed” information refers to printed or imaged information that generally does not change from document to document and may include a general description or body of information about a particular products, service, place, etc. that may be of interest to the intended recipient.

The coating used in the present invention may be applied by flood coating, pattern or spot coating, transfer coating or other means known in the industry. The coating may be applied so as to cover the full length and width of the material or substrate or may be applied in predetermined or selected areas so that only a portion of the substrate or sheet is provided with the faux or pseudo embossment.

The thickness of the coating ranges from about 0.0002″ to about 0.005″ the preferred ranges is preferably from 0.0002″ to about 0.003″ with about 0.002″ being yet still more preferred. Typically, in a preferred embodiment the coating is applied through a flood coat sleeve or printing plate applicator. A particular range of viscosities is generally not required. However those coatings with a higher viscosity will typically produce a greater contrast between the sheet or substrate and the coating that is employed.

For the exemplary embodiment being presently described, one preferred coating is a UV curable varnish, such as FT30LI available from Northwest Coatings Corp., Oak Creek, Wis. 53154 and is composed of various acrylate monomers and oligomers. The coating maintains a boiling point of greater than 200° C., a vapor density of greater than 1 (air=1), an evaporation rate of greater than 1 (n-Butyle Acetate=1) and a vapor pressure of less than 1 (MM HG at 25° C.).

A further material suitable for use in connection with practicing the present invention includes CRAIGCURE™ available from Craig Adhesives and Coatings of Newark, N.J. CRAIGCURE™ is a radiation curable varnish made up of a compounded acrylate monomer/oligomer blend. The varnish has a boiling point of about 176° F.; specific gravity of 1.14 (water=1); vapor pressure of 0.01 mm of Hg @ 20° C.; and an evaporation rate of less than 1 (Butly Acetate=1).

The coating material may comprise 100% of the varnish or the varnish of the exemplary embodiment may contain from 0.1% to 99.9% varnish and then a second component may be provided in a range from 0.1% to 99.9%, with such second coating including pigments, dies, starches, waxes, silicones, stabilizers, drying aids, fragrances and such other elements or components that may add desirable features or characteristics to the coating.

Other material or components that may be suitable for inclusion in connection with the practice of the present invention include Transwhite 36 and 61 which are available from Arcar Graphics, LLC of West Chicago, Ill. and is water based, pigment less ink that includes butyl alcohol, ammonium hydroxide and n-methylpyrrolidone. Transwhite is generally pigment less, but pigments may be added to supplement or compliment the printing that may be applied to the assembly.

NuCoat 8320 is available from NuCoat, Inc. of Plymouth, Minn. which serves as an absorbing agent. PrintAide is available from Arcar Graphics of Ann Arbor, Mich. and includes 2-dimethylaminothanol and ammonia and functions as a drying agent or wetting agent in slowing the drying if necessary. StabilAide may be mixed with water or any other known component or used alone and is available from Arcar Graphics of Ann Arbor, Mich. and is generally used for pH stabilization.

Sericol is available from Sericol of North Kansas City, Kans. and includes acrylate ester, vinaly monomer, acrylated urethane, alkanol amine, barium sulfate and a photoinitator. Sericol is a pigment less material having an absorbing agent contained therein as well as being in a prescribed pH range.

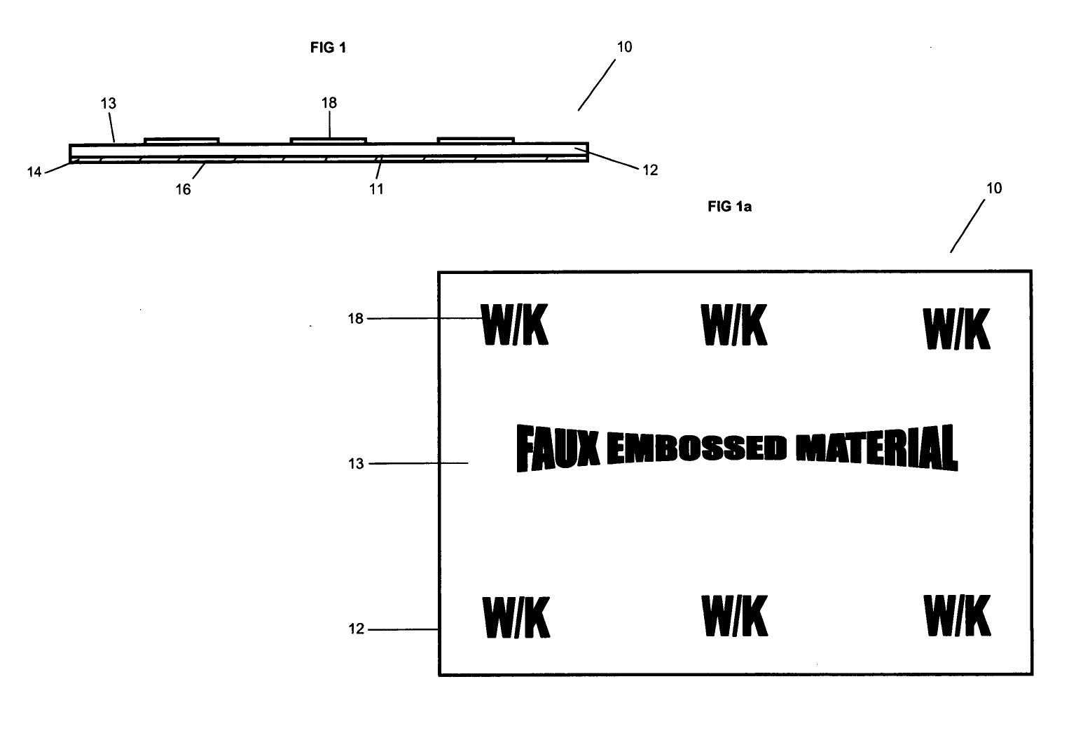

Turning now to FIG. 1, the laminate of the present invention is generally depicted by reference to numeral 10. The laminate includes a substrate 12 having a front face 13 and a back face 11. On the back face 11 is an adhesive 14, such as a pressure sensitive adhesive, that may be covered with a release liner or carrier 16. The adhesive may be any suitable adhesive such as hot melt, acrylic or rewettable that may be used to adhere the laminate to the surface of a business communication document. On the top face 13 of the substrate 12 a coating is provided to create a raised image 18. The image 18 is formed in an intermediate state and becomes permanent after curing as will be described herein.

FIG. 1A shows a front view of the laminate 10 of the present invention so as to more clearly illustrate the raised image 18 on the front face or top face 13 of the substrate 12. In this particular instance the image 18 is depicted as “W/K” but it should be readily understood that the image could take any shape, design, alpha, numeric characters, geometric or random patterns or any other configuration that a user may wish to create.

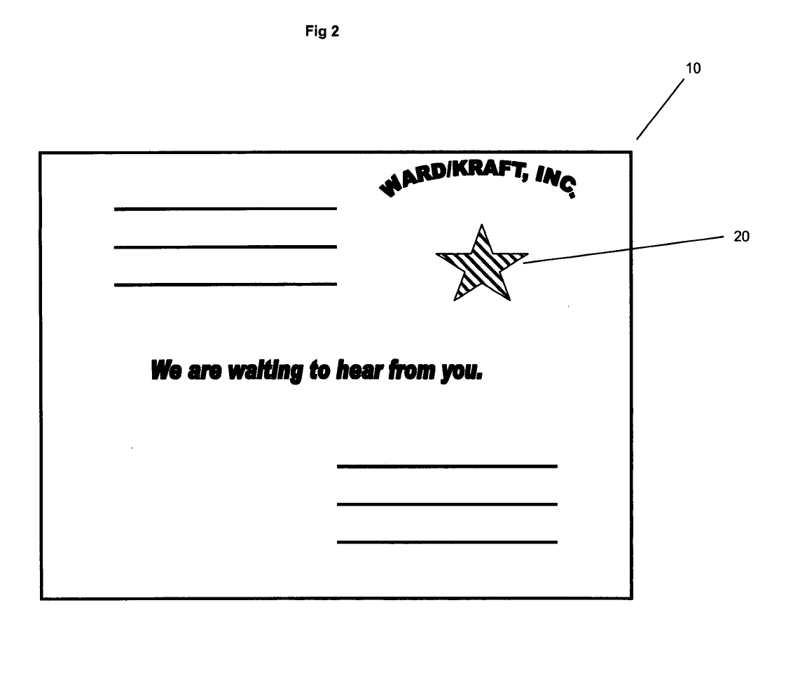

FIG. 2 presents another embodiment of the present invention in which the laminate 10 has been die cut to form a star shape 20. The shaped laminate 20 has a regular occurring pattern of lines, but it should be understood that the patterns could include lines, dots, dashes, segments, geometric elements and combinations thereof in order to achieve a particular arrangement selected by the end user or customer.

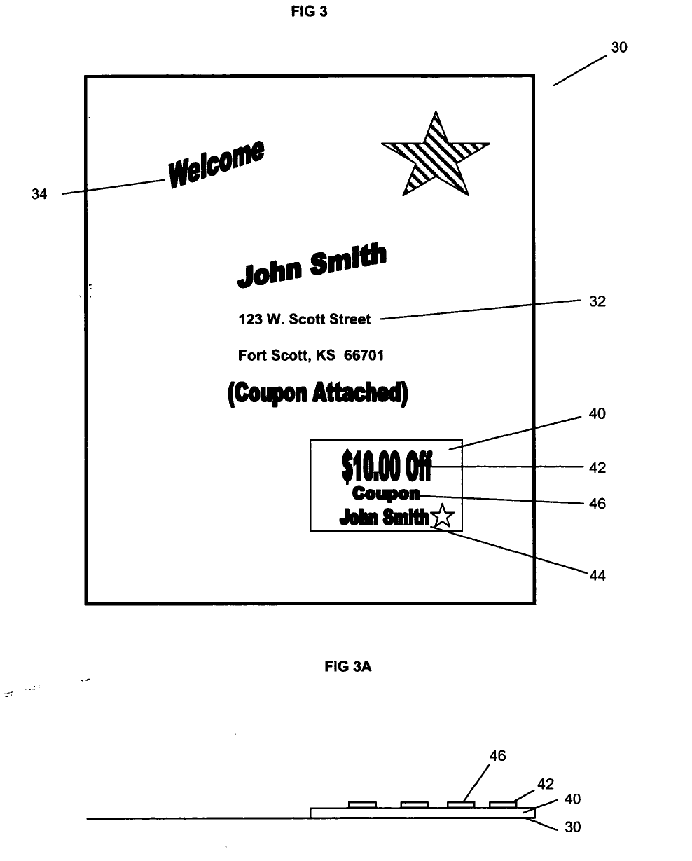

FIG. 3 of the present embodiment is used to illustrate a business communication document depicted generally by reference to numeral 30. The business communication document, in this FIGURE is a business form, however any other business communication document may be utilized in connection with this invention. Business communication documents can be provided in a variety of formats or constructions such as business forms, stationery, business cards, advertising, sales and marketing collateral and such other items used to convey information in a written or imaged form such as mailers, product sheets, brochures, presentation folders, informational sheets and combinations thereof.

The business communication document 30 of FIG. 3 has both a front face and a back face. For the purposes of the present example, only the front face of the business communication document 30 is shown. The document 30 is provided with personalized indicia 32 as well as static or fixed indicia 34 which will be the same from document to document as described above.

To the face of the business communication document 30 the laminate of the present invention 40 is affixed. As can be seen from FIG. 3, the laminate 40 is provided in this example with both personalized information 44 (which corresponds or is substantially similar to the personalized indicia on the document depicted by reference numeral 32) as well as static information 42 which may also match or be similar to other information on the business document such as depicted by reference numeral 46. In this way, personalized laminates may be created and placed on the business communication document to assist in getting the message across. Alternatively, the laminates may only be provided with static or fixed information that may be matched with portions of the business communication document.

FIG. 3A is provided to further illustrate the raised areas created by the coating of the present invention. Substrate 30 has the laminate 40 provided thereon. The indicia or patterns created by the coating described herein are represented by numerical references 42 and 46. These patterns will be visually and tactilely discernable.

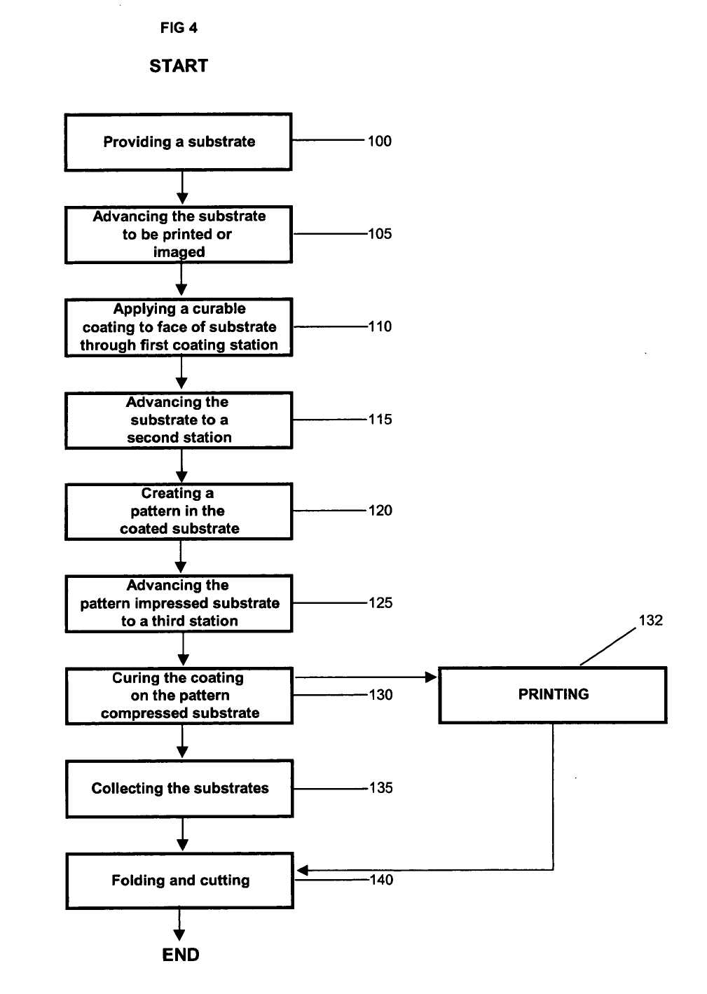

FIG. 4 presents a block diagram of an exemplary method of creating business communication documents or pieces as used in the present invention. Initially, a substrate is provided at step 100. As described previously, the substrate is preferably a cellulosic stock having a basis weight of at least 20 pounds. The substrate is advanced and may be printed or imaged at step 105. Next, at step 110 the laminate is created through the application of a curable coating to the face of the laminate substrate. The coating used in preparing the laminate in an exemplary embodiment is a varnish which may have one or more additives such as pigments added to the coating so as to distinguish the pattern from the substrate to which it has been applied. In a preferred embodiment of the present invention, the coating is applied through the use of a flood coated sleeve.

In preparing the laminate of the present invention, the substrate is advanced to a station at step 115 that is used to apply the pattern to the coated portion of the laminate substrate at step 120. At this point, the coating is still wet and in a fluid state. Depending on the viscosity of the coating that is used, the time between stations can be very short (a few seconds to fractions of a second) or may be increased to allow the coating a chance to dry slightly. In any event, the coating will preferably stay on the surface of the laminate substrate and will not penetrate the surface.

The pattern is applied through the use of rubber or photopolymer plates and exemplary plates are produced under the names Ekaslon RB Cor or Cyrel Dupont, available from Elaslon of San Marcos, Calif. and DuPont, Wilmington, Del., respectively. The pressure of application used is equivalent to that used in conventional flexographic printing and is not significantly strong such that the coating is squeezed out or away from the surface of the substrate. Through the use of such plate material, the manufacturer can relatively inexpensively create plates with various designs and configurations so that patterns that are tailored specifically for the end user.

After the laminate substrate has the pattern created in the coating at step 120, the laminate is again advanced, step 125, to a curing station, step 130. The curing is accomplished through UV bulbs as described below. Once the substrate has been cured, the laminate substrates are collected at step 135.

Application of the adhesive and if present the release layer can occur prior to the application to the coating to the substrate. That is, a pressure sensitive laminate may be purchased from any number of vendors, such as Strata-Tac of Batavia, Ill., in which a substrate has an adhesive coating thereon and may then be coated with the curable coating as provided herein.

In addition to the foregoing steps, the substrate may be printed at step 105 which is preferably done at any time before the coating is applied. As previously indicated, printing step 132 may also be accomplished after the curing step, however it will likely be necessary to utilize an ink or toner anchorage component so that the printing will adhere to the surface of the coating and not be easily rubbed or scuffed off.

Other post coating and curing steps may also be utilized in connection with the present process. Such additional processing can be accomplished and may include folding, cutting, perforating, at step 140 such as that which may be necessary to prepare a presentation folder or other business communication piece.

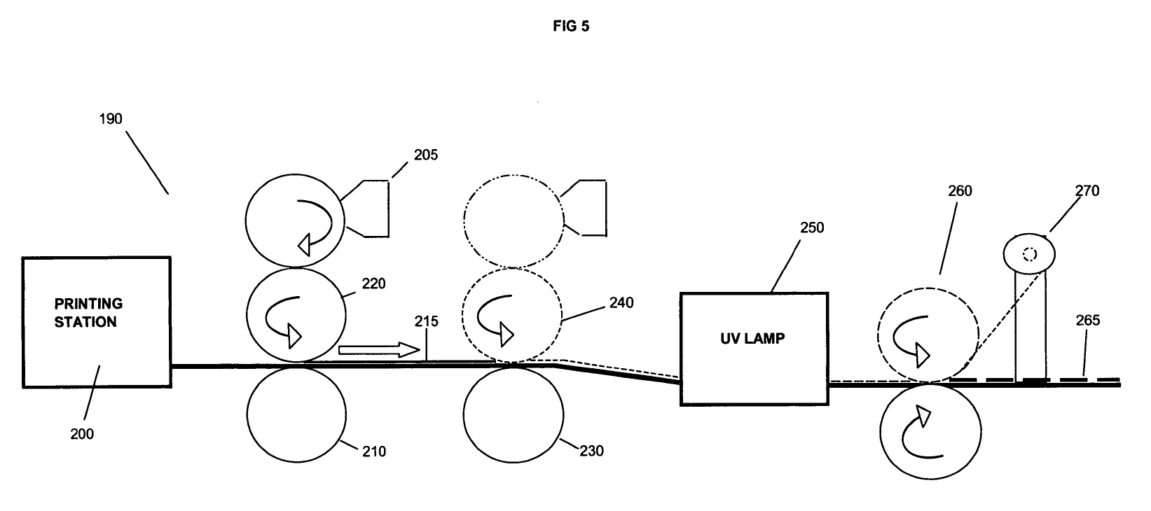

Attention is now directed to FIG. 5 where a schematic of the apparatus used to prepare the business communication piece or document is illustrated. A manufacturing line 190 is used to convey and advance the business communication substrate and laminate through each of the various processing stations as will be described. The business communication substrate first encounters a print station 200, if one is provided, which will apply printed and other information to the surface of the substrate. Such printing may be accomplished generally through non-impact printers such as ink jet or later printers or rotary printing methods for inline printing.

The substrate is coated through the use of a flood coat sleeve roller 220 which is supplied through fountain 205. The substrate is brought into contact with the flood sleeve through use of a cooperating roller 210. The laminate substrate with the coating applied is shown by reference numeral 215. As indicated previously, the coating may be applied across the entire surface of the substrate or only in selected areas of the laminate.

The laminate substrate sheet is advanced in the direction of machine travel and then contacts the pattern roller 240, to which a rubber or other type of flexo plate has been applied. Again a biasing roller 230 is used to press the substrate into operative contact with the pattern roller 240 so that the pattern can be applied to the coating or coated area where the entire surface of the substrate has not been coated. Only pressure that is sufficient to press the pattern into the coating is necessary, and the amount of pressure is equivalent to that used in flexographic printing processes.

The substrate is then advanced, again in a machine direction to a curing station 250 where one or more curing lamps are used to apply curing energy to the coating on the substrate and harden the coating as to create a tactilely discernable, three dimensional pattern.

A die cutting station 260 may be used to cut the laminate into discrete segments for application to the business communication substrate at 265. The remaining matrix may then be rewound at station 270. Alternatively, the laminate could be rewound by a similar equipment configuration if the laminate were not to be die cut at the time of application to the business communication substrate.

In creating marketing collateral for a customer or end user a pattern is created in a plate and a plate is prepared containing the pattern or image that has been selected by the end user. The pattern may be determined through consultations with the customer or through copying or reproducing a particular image or pattern that the customer requests.

The substrate, when used for creating marketing collateral for example, will be a generally smooth sheet that will have some level of glossy appearance. A coating is applied to the substrate and then the coating is contacted with the plate having the pattern at step. Finally, the coating with the pattern resident therein is cured through the use of ultraviolet energy.

In situations where a second or multiple patterns are to be applied, either multiple plates may be used or different stations to apply subsequent patterns are set up. In this way, the consumer is not limited to the use of a single pattern as may be necessary when purchasing conventional stock.

Once the substrate has been created with the coating applied thereto and it has been cured, the sheet is in an intermediate condition in that the sheet or coated substrate will need to be subjected to at least one additional step prior to being ready for use. The intermediate sheet or substrate can be collected for later processing such as the folding and cutting that may be necessary to create a presentation folder or alternatively assembling additional pieces to be used in connection with the business communication document or piece.

The curing of the coating as used in the present invention is accomplished by at least one if not multiple UV curing stations which contain UV bulbs that are provided for curing purposes. The curing stations may use “H” bulbs described below and/or the Gallium bulb, which is also described below.

In practicing an exemplary embodiment of the present invention, a series of UV curing bulbs, which can be positioned in a side by side, adjacent or sequential configuration, can be used. In an exemplary embodiment, a single bulb may allow a UV cure rate of approximate 50 feet per minute, while plural bulbs disposed in a side-by-side or adjacent configuration permits a higher curing rate of approximately 75 feet per minute. Obviously, other curing station configurations may be used in order to increase the possible through put rate of the equipment and processing of the substrates to be printed.

Exemplary bulbs used in the embodiment of the present invention are “H” bulbs and Gallium doped bulb suitable for use in the UV curing processes, however, it should be understood that other UV curing may be used in accordance with the present invention and the present invention is not limited hereto.

The “H” bulb is generally known as a mercury vapor bulb and is used typically for top surface curing applications. The Gallium doped bulb is used in connection with a requirement for deeper penetration. The UV bulbs such as those described above along with reflectors, to focus or concentrate the energy, are available from the GEW Company, located in North Royalton, Ohio. Alternatively, a combination of both topical and penetration curing can result in a combination of curing energies sufficient to carry out the present invention. It should be understood that other curing technologies may be used in the preparation of the coating on the substrate for the present invention.

The exemplary coating described above, normally creates a glossy finish and can be further manipulated through the addition of pigments, dyes, starches, etc. to produce a dulled or matte finish in the final product or a coating having a particular color or appearance.

It will thus be seen according to the present invention a highly advantageous laminate assembly with patterned coating has been provided. While the invention has been described in connection with what is presently considered to be the most practical and preferred embodiment, it will be apparent to those of ordinary skill in the art that the invention is not to be limited to the disclosed embodiment and that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A laminate for use with business communication documents, comprising;
a substrate having top and bottom faces;
an adhesive applied to said bottom face;
a coating applied to said top face, said coating is used to create a tactilely discernable pattern that is formed by curing said coating on said top face after application to said substrate;
a carrier applied over said adhesive;
a business communication document having first and second faces and having personalized indicia and printed information imaged on at least said first face; and
wherein said laminate is applied to said first face in proximity of said personalized indicia to form a personalized communication.

2. A laminate as recited in claim 1, wherein said laminate includes a release layer that is provided over said adhesive.

3. A laminate as recited in claim 1, wherein said adhesive is a pressure sensitive adhesive.

4. A laminate as recited in claim 1, wherein said laminate is die cut to create unique shapes.

5. A laminate as recited in claim 1, wherein said coating comprises approximately 100% of a curable varnish.

6. A laminate as recited in claim 1, wherein said coating comprises a first component ranging from 0.1% to about 99.9% of a curable varnish and a second component ranging from around 0.1% to about 99.9%.

7. A laminate as recited in claim 6, wherein said second component is selected from a group including pigments, dies, starches, waxes, silicones, stabilizers, drying aids, fragrances and combinations thereof.

8. A laminate as recited in claim 1, wherein said pattern is substantially identical to at least a portion of one of said printed information or personalized indicia.

9. A laminate as recited in claim 1, wherein said business communication document is selected from a group including mailers, business forms, product sheets, brochures, presentation folders, informational sheets, stationery and combinations thereof.

10. A business communication document, comprising;
a printable substrate having first and second faces, at least said first face is provided with a communication;
a laminate, including a substrate having top and bottom faces, said bottom face is provided with an adhesive and said top face has a raised image thereon that has been created from a curable varnish based coating and a carrier provided over said adhesive; and
wherein said laminate is applied to said first face of said substrate.

11. A business communication document as recited in claim 10, wherein said image is similar to at least a portion of said communication.

12. A business communication document as recited in claim 10, wherein said coating comprises a first component ranging from 0.1% to about 99.9% of a curable varnish and a second component ranging from around 0.1% to about 99.9% and said second component is selected from a group including pigments, dies, starches, waxes, silicones, stabilizers, drying aids, fragrances and combinations thereof.

13. A business communication document as recited in claim 10, wherein said coating is cured by ultraviolet energy at, at least 50 feet per minute.

14. A business communication document as recited in claim 10, wherein said business communication document is selected from a group including mailers, business forms, product sheets, brochures, presentation folders, informational sheets, stationery and combinations thereof.

15. A method of preparing business communication documents having a raised image laminate provided thereon, comprising the steps of;
providing a substrate having first and second faces, said substrate is capable of having a printed communication applied thereto;
imaging a communication on said substrate;
creating a laminate having a raised image thereon, said raised image is formed by applying a curable coating to a face of the laminate; and
applying said laminate to a portion of said substrate through use of an adhesive applied to a face of said laminate opposite of the face having said raised image thereon.

16. A method as recited in claim 15, wherein said image has similar characteristics to said communication imaged on said substrate.

17. A method as recited in claim 15, including a further step of collecting said laminate in a continuous form prior to the step of applying said laminate.

18. A method as recited in claim 15, including a further step of imaging on said face of said laminating prior to applying said curable coating.

19. A method as recited in claim 15, including a further step of die cutting said laminate prior to the step of applying said laminate to the business communication document.

20. A method as recited in claim 15, wherein said coating comprises a first component ranging from 0.1% to about 99.9% of a curable varnish and a second component ranging from around 0.1% to about 99.9% and said second component is selected from a group including pigments, dies, starches, waxes, silicones, stabilizers, drying aids, fragrances and combinations thereof.
